(19) United States
(12) Patent Application Publication
(10) Pub. No.: US 2006/0075229 A1
(43) Pub. Date: Apr. 6, 2006

(54) Method and apparatus for maintaining a communications connection while guarding against bandwidth consuming attacks

(76) Inventor: James Allen Marek, Anamosa, IA (US)

Correspondence Address: Jack J'maev, Suite H, 187 W. Orangethorpe Ave., Placentia, CA, 92870, US

(21) Appl. No.: 10/957,534

(22) Filed: Sep. 30, 2004

(51) Int. Cl. H04L 9/00; G06F 12/14; H04L 9/32; G06F 11/30

(52) U.S. Cl. 713/168; 713/189

(57) ABSTRACT

A method and apparatus for maintaining a communications connection with data packet authentication wherein a data packet is received. For each received data packet, a determination is made as to which communications connection the received data packet is associated with, authenticating the data packet to the associated communications connection and forwarding the data packet when it is authentic to the communications connection.

### BACKGROUND

Computer networks are subject to various forms of hacking attacks. One common form of attack comprises a bandwidth consuming attacks, also known as a “flooding” attack. Generally, a flooding attack is mounted by introducing heavy amounts of networking traffic into the network infrastructure. Typically, a flooding attack is directed against a particular communications connection.

Consider a typical communications connection. The typical communications connection is established through the use a protocol. For example, a common protocol is the transfer communications protocol/Internet protocol (TCP/IP). Connections are established using a protocol by requesting a connection from a particular source device to a particular destination device. Typically, a source device is identified using a source address and a source port number. Likewise, a destination device is generally identified using a destination address any destination port number. The use of a source address, a source port number, a destination address and a destination port number are particular to TCP/IP connections. However, it should be appreciated that any form of connection identifier can be used to distinguish a particular connection established from a source device to a destination device.

A flooding attack, then, is an attempt to dispatch numerous data packets into a communications fabric wherein each data packet dispatch into the communications fabric is associated with a particular connection. In other words, numerous data packets start to flow through a network and each data packet will have a connection identifier associated with a communications connection that is the target of the attack. For example, where a TCP/IP protocol is used, all of the road data packets introduced into the network fabric will have a source address, a source port, a destination address any destination port which are equal to other legitimate data packets associated with the communications connection.

A traditional form of guarding against bandwidth consuming attacks has relied on the notion of bandwidth limitation. By limiting the bandwidth on a connection-by-connection basis, a data packet forwarding device is able to limit the scope of an attack. It data packet forwarding device can include, but is not necessarily limited to a network switch and a network router. Generally, because a bandwidth consuming attack is introduced at the fringe of a network, bandwidth limitation is usually employed at the edge of a given network.

Although bandwidth limitation can be effectively used to limit the scope of a bandwidth consuming attack, is difficult to really ascertain the required amount of bandwidth and a particular connection may need over time. Especially in light of the fact that a particular connection may have a time-burying bandwidth demand profile, bandwidth limitation techniques may end up preventing legitimate data flow. For example, where a bandwidth limitation mechanism has established a maximum bandwidth for particular connection, legitimate and instantaneous surges or rapid changes in sustained bandwidth may be dropped from the network connection.

### SUMMARY

A method and apparatus for maintaining a communications connection with data packet authentication comprising receiving a data packet, determining a communications connection with which the received data packet is associated with, authenticating the data packet to the associated communications connection and forwarding the data packet when it is authentic to the communications connection.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram depicts one example method and for maintaining a communications connection while concurrently guarding against bandwidth consuming attacks.

FIG. 2 is a flow diagram that depicts several alternative methods for authenticating a data packet.

FIG. 3 is a flow diagram that depicts alternative methods for determining a decryption key.

FIG. 4 is a flow diagram that depicts yet another alternative method for determining a decryption key using an identity-based mechanism.

FIG. 5 is a flow diagram that depicts yet another alternative method for maintaining a connection while guarding against bandwidth consuming attacks.

FIG. 6 is a flow diagram that depicts alternative methods wherein a notification is sent to a communications manager when a data packet cannot be authenticated.

FIG. 7 is a block diagram that depicts one example embodiment of a data forwarding device.

FIG. 8 is a pictorial representation of one example embodiment of a data packet.

FIG. 9 is a block diagram of one alternative embodiment of authentication unit.

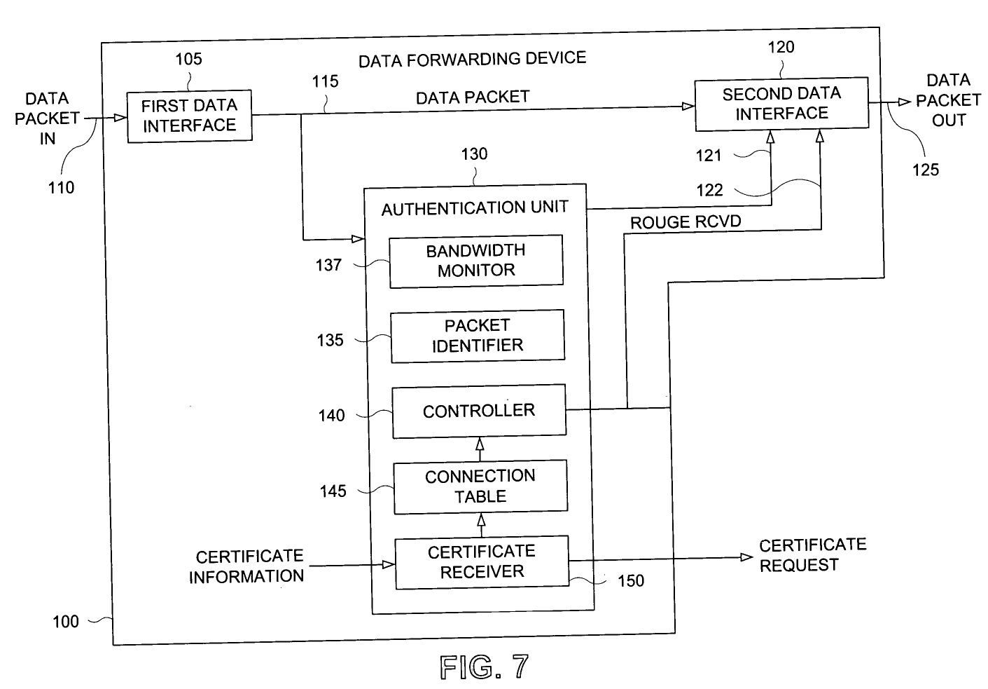

FIGS. 7 and 10 further illustrate that, according yet another alternative embodiment, the authentication unit 130 further comprises a certificate receiver 150.

### DETAILED DESCRIPTION

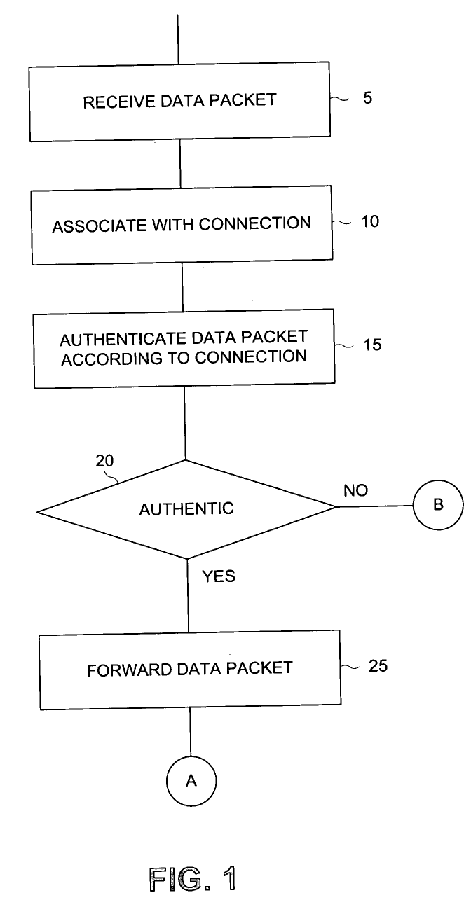

FIG. 1 is a flow diagram depicts one example method and for maintaining a communications connection while concurrently guarding against bandwidth consuming attacks. According to this example method, a data packet is received (step 5). The data packet is assumed to be associated with a communications connection. Accordingly, a communications connection with which the data packet is associated with is determined (step 10). In order to guard against a bandwidth consuming attacks, the authenticity of the data packet is determined (step 15). It should be appreciated that the authenticity of the data packet is confirmed in association with a particular communications connection. When the data packet is determined to be authentic (step 20), it is forwarded (step 25).

According to one variation of the present method, when a data packet arrives, a connection identifier is typically determined for the data packet. The connection identifier, according to yet another variation of the present method, is determined by forming a connection identifier according to information found in a header that is included with the data packet. For example, where a data packet conforms to the TCP/IP protocol, a connection identifier, according to yet another derivative method, is formed by including the source address, a source port number, a destination address, and a destination port number all of which are included in a TCP/IP header. The notion of a connection identifier does not need to be based or otherwise grounded on any particular protocol (e.g. TCP IP). Accordingly, the claims appended hereto are not intended to be limited to any embodiments that rely on TCP IP or any other illustrative protocol presented herein.

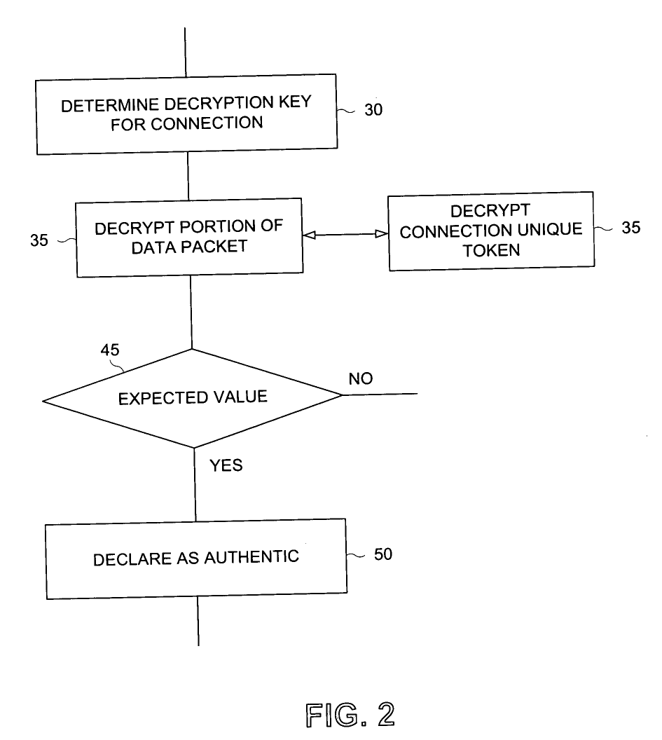

FIG. 2 is a flow diagram that depicts several alternative methods for authenticating a data packet. Although there are several alternative methods contemplated for authenticating a data packet, one example illustrated method provides for determining a decryption key for the associated communications channel (step 30). According to this illustrative method, a portion of a data packet is decrypted (step 35). According to one variation of the present method, a connection-unique token included in the data packet is decrypted (step 40). When the decrypted portion of the data packet matches an expected value (step 45), the data packet is declared to be authentic (step 50). It can be appreciated that when a small portion of a data packet is decrypted according to this present method, a very little processing overhead is required to authenticate a data packet. According to one illustrative use case, a portion of the data packet is encrypted and stored in the data packet before it is conveyed to a network. When the data packet arrives in a node, the corresponding portion of the data packet is extracted from the data packet and decrypted according to the present method. It should be further appreciated that, according to one variation of the present method, every connection will typically have associated therewith a connection-unique token and a decryption key. It is the connection-unique token that is a “shared-secret” known only to a legitimate source node and a data forwarding device constructed to embody the present method and all of its teachings.

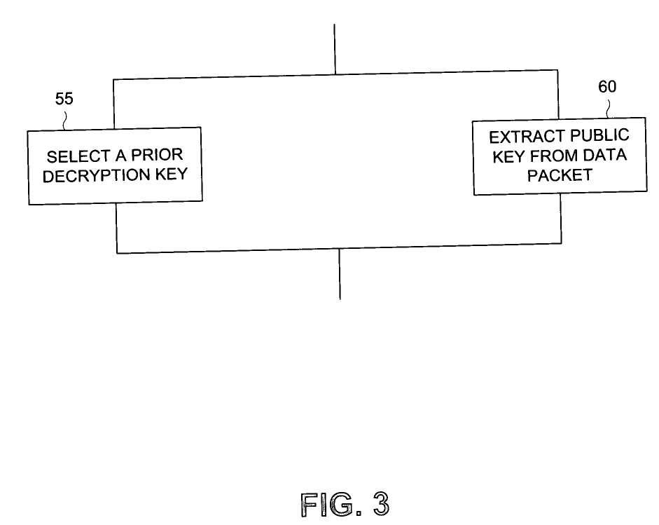

FIG. 3 is a flow diagram that depicts alternative methods for determining a decryption key. According to one variation of the present method, a decryption key is determined by selecting an a priori decryption key (step 55) according to a connection identifier. As already illustrated, when a data packet arrives a connection identifier is determined for the data packet. The determined connection identifier is used to discover a connection-unique decryption key. Accordingly, the connection-unique decryption key is typically stored in a forwarding device that embodies the present method. According to yet another variation of the present method, a public key is extracted from an arriving data packet itself (step 60) as a method for determining a decryption key. The public key is then used to decrypted portion of the arriving data packet according to the techniques and teachings of the present method.

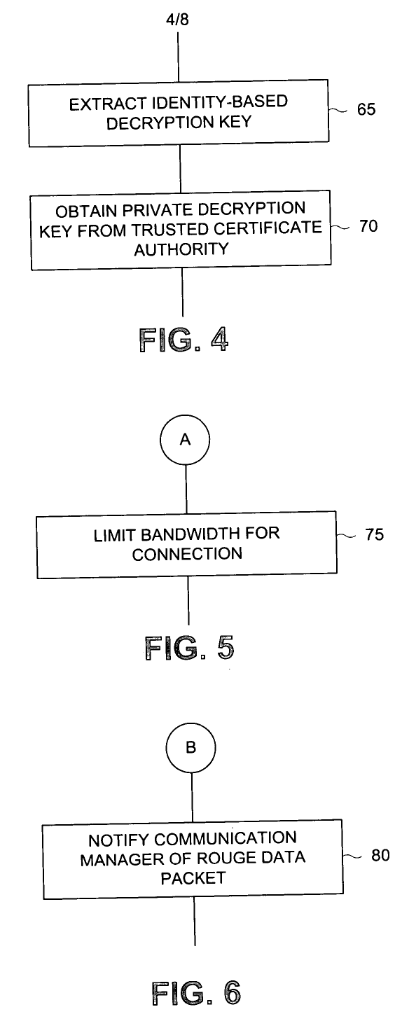

FIG. 4 is a flow diagram that depicts yet another alternative method for determining a decryption key using an identity-based mechanism. According to this variation of the present method, an identity-based decryption key is extracted from an arriving data packet (step 65). A private decryption key is then obtained from a trusted certificates authority (step 70) according to the extracted identity-based decryption key.

FIG. 5 is a flow diagram that depicts yet another alternative method for maintaining a connection while guarding against bandwidth consuming attacks. According to this alternative method, authenticate a data packet is still subject to a limitation on bandwidth for particular connection (step 75). According to this alternative embodiments, then with limitation can be used as a secondary defense even when an authentication mechanism using encryption is otherwise compromised.

FIG. 6 is a flow diagram that depicts alternative methods wherein a notification is sent to a communications manager when a data packet cannot be authenticated. According to this variation of the present method, a notification is sent to communications manager (step 80) when a rouge data packet is received. Accordingly, when a communications manager is notified that a row data packet was received, the communications manager can take steps to overcome any compromise in connection quality.

FIG. 7 is a block diagram that depicts one example embodiment of a data forwarding device. A data forwarding device includes any device that receives a data packet from one network interface and forwards it to a second network interface. For example, a network switch, a network router, a firewall, and a gateway are all examples of data forwarding devices. According to this example embodiment, a data forwarding device 100 comprises a first data interface 105, a second data interface 120 and authentication unit 130. In operation, the first data interface 105 receives a data packet 110. A data packet is made available 115 to the second data interface 120 and to the authentication unit 130. The authentication unit 130 includes a packet identifier, a connection to table and a controller. The packet identifier 135 includes a connection identifier register which captures a convention identifier for a received data packet 115. Accordingly, very somebody mince of the connection identifier register can be constructed. For example, according to one alternative embodiment, the connection identifier register can be constructed to accommodate TCP/IP connection identifier formats. The connection cable stores a connection record for a connection according to a connection request sequence. The packet identifier 135 will typically provide for identifying a connection request. In response to a connection request, a new record is formed in the connection cable 145. It should be appreciated that the connection table 145 included in one alternative embodiment of the authentication unit 130 will have stored therein a priori values of decryption key is for a one or more of anticipated connection identifiers. In operation, the controller 140 authenticate to data packet received by the first data interface 105. When so authenticated, the controller will command the second data interface 120 by means of a send packet signal 121 to propagate the data packet available 115 from first data interface 105. In the event that a data packet can not be authenticated, the controller 140 will generate a rouge received signal 122. The rouge received signal 122 causes the second data interface 120 to dispatch a notification message to a network manager.

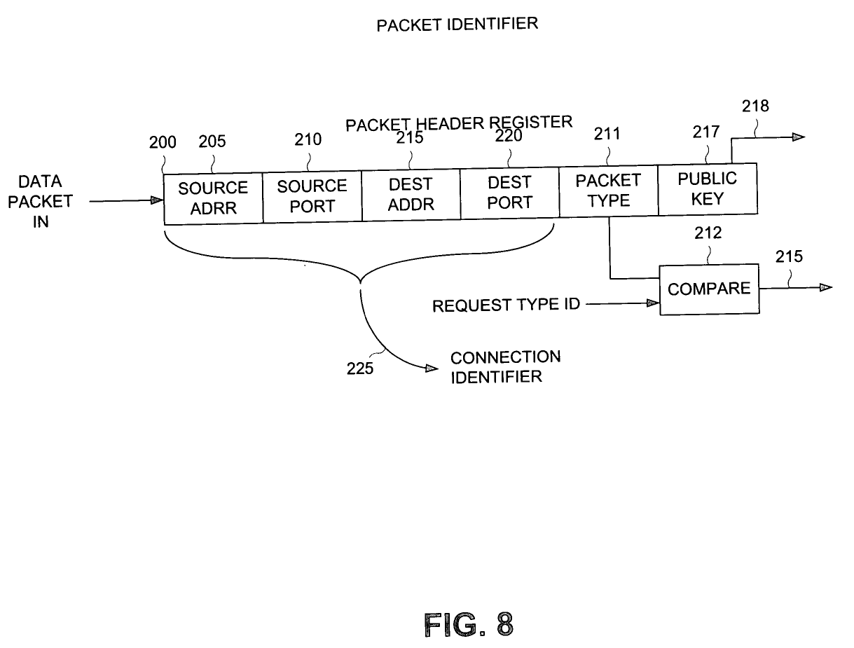

FIG. 8 is a pictorial representation of one example embodiment of a data packet. According to one alternative embodiment, a data packet 200 includes a packet header according to yet another alternative embodiment, the packet header one conforms to a TCP/IP packet header and includes a source address 205, a source port 210, a destination address 215 and a destination port 220. Collectively, according to this alternative embodiment, these form a connection identifier 225. A data packet, according to one alternative embodiment, further comprises a packet tight field 211. According yet another alternative embodiment, a data packet further includes a public key 217. According to yet another alternative embodiment, a data packet 200 further includes a public key that conforms to an identity-based mechanism.

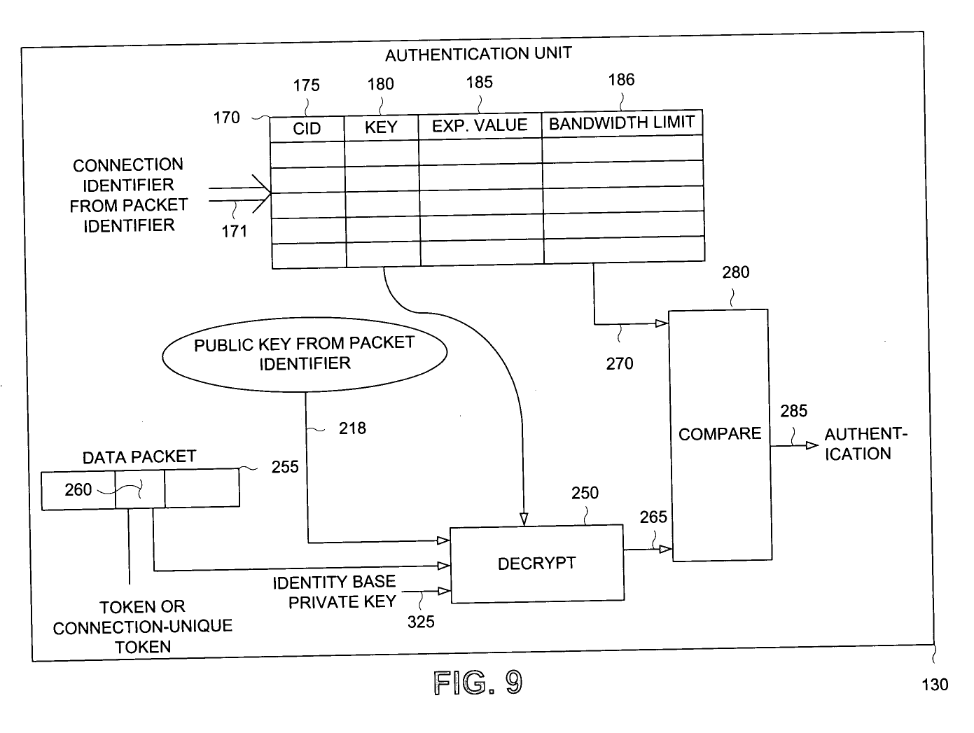

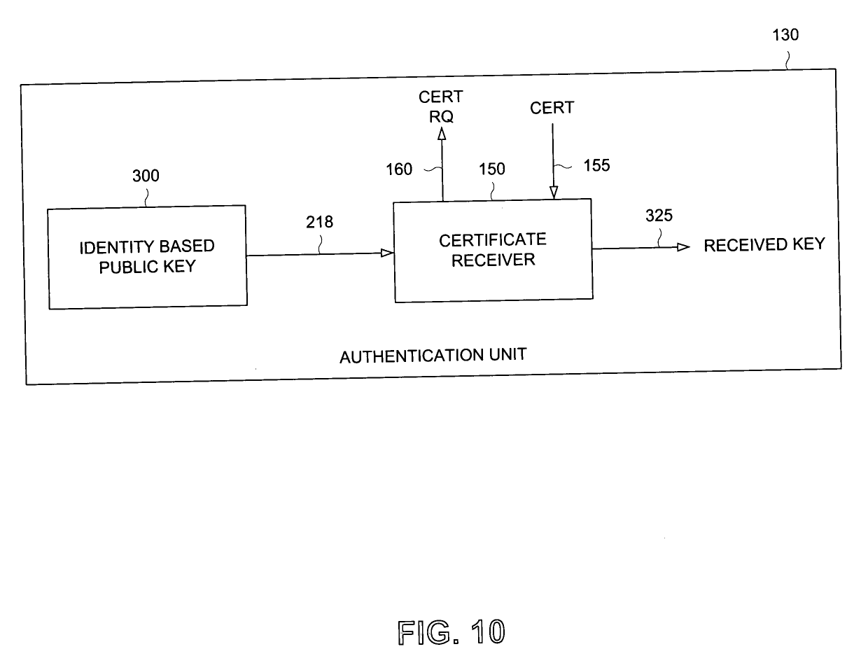

FIG. 9 is a block diagram of one alternative embodiment of authentication unit. According to this alternative embodiment, and authentication unit 130 further comprises a decryptor 250, and a comparator 280. The connection table 170 of this alternative embodiment further includes a connection identifier (CID) 135 field, a decryption key field 180 and an expected value field 185. In operation, this alternative alignment of the authentication unit 130 uses a connection identifier 171 received from the packet identifier 135 to select one of the records stored in the connection cable 170. Using the selected record, a decryption key 180 is provided to the decryptor 250. A portion of a data packet 255 is presented to the decryptor which then generates a decrypted representation of that portion of the data packet 265. The decrypted representation of a portion of a data packet 265 and the expected value 270 received from the expected value field 185 of the connection table 170 are compared with each other by the compare 280. When the expected value 270 is substantially equivalent to the decrypted portion 265 of the data packet 255 at authentication signal is generated 285 by the comparator 280.

FIG. 9 further illustrates that, according to yet another alternative embodiment, the connection table 170 includes only expected value field 185 and a connection ID field 175. According to this alternative embodiment, a decryption key field 180 is not required. In this situation, a public key that is extracted from the data packet 218 is presented to the decryptor 250 in lieu of a decryption key that would have otherwise been stored in the connection table 170. Accordingly, the decryptor 250 of this alternative embodiment uses a public/private key algorithm in order to decrypt a portion of a data packet. It is the data packet identifier 135 that extracts a public key from a received data packet and provides the public key 218 to the decryptor 250 from an intermediate holding register. Also according to this alternative embodiment of the authentication unit one or 30, the expected value 270 is received from the connection table 170 provided to the comparator 280. The comparator 280 generates an authentication signal 285 when the decrypted portion 265 of a data packet is substantially equivalent to the expected value 270 received from the connection table 170. It should be further appreciated that the connection table 170 selects a particular record according to a connection identifier 175 received from the packet identifier 135.

FIGS. 7 and 10 further illustrate that, according yet another alternative embodiment, the authentication unit 130 further comprises a certificate receiver 150. According to this alternative embodiment, the certificate receiver 150 generates a certificate request 160 when a data packet 115 includes an identity-based public decryption key 218. Accordingly, the certificate receiver 150 uses the identity-based public decryption key 218 to issue a certificate request 160. The certificate receiver 150 receives certificate information 155, which is typically in the form of a private key 325 that is obtained from a trusted certificate authority. The private key 325 is then directed to the decryptor 250. The decryptor 250 the decrypts a portion of a data packet 255 in order to generate a version of that portion of the data packet. The decrypted portion 265 of the data packet 255 is compared against the expected value 270 received from the connection table 170. A comparator 280 included in this alternative embodiment of an authentication unit 130 generates an authentication signal 285 when the expected value 270 received from the connection table 170 is substantially equivalent to the decrypted portion 265 of the data packet 255.

FIG. 7 further illustrates that according to one alternative embodiment to the authentication unit 130 further comprises a band with monitor 137. In this alternative embodiment, the connection table 145, as depicted in this FIG. 9, includes a bandwidth limited field 186. The bandwidth limit field 186 for a record selected by the connection identifier 171 is used as a bandwidth limit indicator for a particular connection. The bandwidth monitor 137 maintains an average bandwidth tally for each connection that the authentication unit 130 has cognizance over. As such, when a data packet arrives, the bandwidth monitor 137 will compare the average data bandwidth tally to the indicator received from the bandwidth limit field 186 included in the connection table. When the limitation is exceeded, the data packet will not be authenticated.

While the method and apparatus have been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

What is claimed is:

1. A method for maintaining a communications connection comprising:
receiving a data packet;
determining a communication connection with which the received data packet is associated with;
authenticating the data packet to the associated communications connection; and
forwarding the data packet when it is authentic to the communications connection.

2. The method of claim 1 wherein authenticating the data packet comprises:
determining an encryption key for the associated communications channel;
decrypting a portion of the data packet;
declaring the data packet as authentic when the decrypted portion of the data packet is substantial equivalent to an expected value.

3. The method of claim 2 wherein determining the encryption key comprises selecting an a prior encryption key according to a connection identifier.

4. The method of claim 2 wherein determining the encryption key comprises extracting a public decryption key from the data packet.

5. The method of claim 2 wherein determining the encryption key comprises extracting a public identity-based decryption key from the data packet and obtaining a private decryption key from a trusted certificate authority.

6. The method of claim 2 wherein decrypting a portion of a data packet comprises decrypting a connection-unique token.

7. The method of claim 1 further comprising limiting the bandwidth allowable for the associated communications connection.

8. The method of claim 1 further comprising notifying a communications manager that a rouge data packet was received in associated with the communications connection.

9. A data forwarding device comprising:
first data interface capable of receiving a data packet;
second data interface capable of transmitting a data packet;
authentication unit comprising:
packet identifier comprising a connection identifier register capable of capturing a connection identifier for a received data packet;
connection table capable of storing a connection record for a connection according to a connection request sequence;
controller capable of authenticating a data packet received by the first data packet according to a record stored in the connection table and further capable of causing the second data interface to transmit the received data packet when it is so authenticated.

10. The data forwarding device of claim 9 wherein the connection table includes an encryption key field and an expected value field for each record stored therein and the authentication unit further comprises:
decryptor capable of generating a decrypted portion of a received data packet according to a decryption key received from the connection table and wherein the connection table provides an encryption key and an expected value according to a connection identifier it receives from the packet identifier; and
comparator capable of generating an authentication signal when the decrypted portion of a received data packet is substantially equivalent to an expected value received from the connection table.

11. The data forwarding device of claim 10 wherein the connection table is populated with a prior values of decryption keys for a plurality of connection identifiers.

12. The data forwarding device of claim 9 wherein the connection table includes an expected value field for each record stored therein and wherein the packet identifier included in the authentication unit further comprises a public key capture register that extracts a public decryption key from a received data packet and wherein the authentication unit further comprises:
decryptor capable of generating a decrypted portion of a received data packet according to a public decryption key received from the packet identifier and wherein the connection table provides an expected value according to a connection identifier it receives from the packet identifier; and
comparator capable of generating an authentication signal when the decrypted portion of a received data packet is substantially equivalent to an expected value received from the connection table.

13. The data forwarding device of claim 9 wherein the connection table includes an expected value field for each record stored therein and wherein the packet identifier included in the authentication unit further comprises an identity-based public key capture register that extracts an identity-based public decryption key from a received data packet and wherein the authentication unit further comprises:
certificate receiver capable of dispatching the identity-based public decryption key to a trusted certificate authority and receiving an identity-based private key from said trusted certificate authority;
decryptor capable of generating a decrypted portion of a received data packet according to an identity-based private key received from the certificate receiver and wherein the connection table provides an expected value according to a connection identifier it receives from the packet identifier; and
comparator capable of generating an authentication signal when the decrypted portion of a received data packet is substantially equivalent to an expected value received from the connection table.

14. The data forwarding device of claim 9 wherein the authentication unit further comprises a bandwidth monitor and wherein the table unit further includes a bandwidth limit field for every record stored therein and wherein the controller prevents a data packet from being forwarded when a connection record selected by the connection identifier exceeds the bandwidth limitation specified in the selected connection.

15. The data forwarding device of claim 9 wherein the controller included in the authentication unit causes the second data interface to dispatch a rouge data packet notification when an arriving data packet fails to be authenticated.
